(19) United States
(12) Patent Application Publication
(10) Pub. No.: US 2009/0290011 A1
(43) Pub. Date: Nov. 26, 2009

(54) CALL PROCESSING METHOD, SERVICE CONTROL DEVICE AND CALL PROCESSING SYSTEM

(75) Inventors: Xin Yin, Shenzhen (CN); Yukui Zhang, Shenzhen (CN)

Correspondence Address: Huawei Technologies Co., Ltd.;c/o Darby & Darby P.C., P.O. Box 770, Church Street Station, New York, NY, 10008-0770, US

(73) Assignee: Huawei Technologies Co., Ltd., Shenzhen (CN)

(21) Appl. No.: 12/472,646

(22) Filed: May 27, 2009

Related U.S. Application Data
(63) Continuation of application No. PCT/CN2007/070347, filed on Jul. 24, 2007.

(30) Foreign Application Priority Data
Nov. 27, 2006 (CN) 200610140321.7

(51) Int. Cl. H04N 7/14; H04L 9/32

(52) U.S. Cl. 348/14.01; 726/2; 348/E07.077

(57) ABSTRACT

A call processing method, service control device and call processing system is provided. The method includes: correspondence relationship between a called number and a manage number is pre-established; service authentication of a caller is performed upon reception of information on a call request initiated by the caller to the called number; a call to the called number is initiated with the management number after authentication is passed; and a called terminal identifies the managed number and sets up communication with the caller after identification is passed, thereby avoiding direct calling of the caller to the called number without any authentication flow and improving service security.

### CROSS-REFERENCE TO RELATED APPLICATIONS

This application is a continuation of International Application No. PCT/CN2007/070347, filed on Jul. 24, 2007, which claims the benefit of Chinese Patent Application No. 200610140321.7, filed on Nov. 27, 2006, both of which are hereby incorporated by reference in their entireties.

### FIELD OF THE INVENTION

The present invention relates to call processing technologies and in particular to a call processing method, service control device and call processing system.

### BACKGROUND OF THE INVENTION

With the development of telecommunication networks, the provision of abundant video services over the telecommunication networks has become an inevitable trend, and instant and lively information interaction is changing the life of people. People's requirements for contents and forms of communication are increasingly high and they are not satisfied with the traditional voice communication any longer. What people really need are lively video phone services.

A mobile video phone provides lively and abundant multimedia visual phone services in the mobile communication field, which is honored as a 3G “Killer Application”, and the mobile video phone services become one of major driving forces for 3G deployment. The Third Generation Partnership Project, 3GPP, R99 and subsequent versions thereof define visual phone services based upon the circuit domain i.e. Third Generation-H.324 Mobile, H.324 protocol of The Third Generation Mobile Network, 3G-324M. Currently, the 3GPP defines video phone services based upon a circuit domain.

Referring to FIG. 1, it is a schematic diagram of an existing mobile communication network. According to the definition of the 3GPP, a user initiates a call to another user of the same office in a basic flow as follows.

(1) A calling user equipment 101 initiates a call request to a Mobile Switching Center, MSC 107;

(2) The MSC 107 initiates an authentication process for the purpose of checking whether to allow an access of a terminal to a network. In this process, the MSC obtains an authentication set from a Home Location Register, HLR, 108. If identity authentication regarding allowance of an access to the network is passed, then the flow proceeds; otherwise, the call is terminated.

(3) The calling user equipment 101 sends a call setting-up message to the MSC 107 after passing identity authentication and receiving a service request acceptance message, and the MSC 107 returns a call processing message to the caller upon reception of the call setting-up message.

(4) As calling-side equipment, a Radio Network Controller, RNC, 103, a Media Gate Way, MGW, 105 and the MSC 107 begin to set up bearer resources at the access side. The MSC 107 inquires an HLR 108 about routing information; the HLR 108 obtains a roaming number from a Visited Location Register, VLR, 106; and after obtaining call data, the MSC 107 triggers the VLR 106 to initiate a paging process to a callee with a calling number.

(5) Upon receiving a paging response message from the callee, the MSC 107 sends a call setting-up message to a called user equipment 102 through a Radio Network Controller, RNC, 104 at the called end.

(6) The MSC 107 awaits off-hook of the callee and sends a put-through message to the calling user equipment 101 upon off-hook.

(7) The calling user equipment 101 sets up a video connection with the called user equipment 102.

A requirement on a video phone service in which images and voices can be obtained directly from the opposite party is to guarantee privacy and security of information of a called user. As can be seen from the above call flow, the subsequent call flow proceeds still with the calling number even after identity authentication of the caller is passed; and there may be a loophole that a calling number for which service authentication is not performed can obtain the actual number that is called and thus call the called number directly, and this loophole may give rise to presence of a hidden danger with respect to security of the information of the called user.

### SUMMARY OF THE INVENTION

Embodiments of the invention provide a call processing method, service control device and call processing system to achieve initiation of a call to a callee with a managed number and to improve service security.

In view of above, the invention can be practiced through the following technical solutions.

A call processing method includes: receiving a call request including a called number from a caller; authenticating the caller; obtaining a managed number corresponding to the called number according to a preset correspondence relationship between the called number and the managed number after the caller passes authentication; and initiating a call to the called number with the managed number.

A service control device includes: a data storage unit adapted to store data of a correspondence relationship between a called number and a managed number; a service authentication unit adapted to receive a call request including the called number from a caller and to perform service authentication of the caller; a managed number inquiry unit adapted to inquire the data storage unit about the managed number corresponding to the called number after the caller passes service authentication; and a call initiation unit adapted to initiating a call to the called number with the managed number.

A call processing system includes: a service control device adapted to receive a call request including a called number from a caller, to authenticate the caller, to obtain a managed number corresponding to the called number according to a preset correspondence relationship between the called number and the managed number after the caller passes authentication and to initiate a call to the called number with the managed number; and a called terminal adapted to identify the managed number and to set up communication with the caller after identification is passed.

According to the above technical solutions, in the invention, because a correspondence relationship between a called number and a managed number is pre-established, service authentication of a caller is performed upon reception of information on a call request initiated by the caller to the called number; a call to the called number is initiated with the management number after authentication is passed; and a terminal to which the called number belongs identifies the managed number and sets up communication with the caller after identification is passed. Because the called terminal only receives call information sent from the managed number and identifies the received managed number upon reception of the call information, it is possible to avoid direct calling by the caller to the called number without any authentication flow, to guarantee privacy of information of a called user and to improve service security.

### BRIEF DESCRIPTION OF THE DRAWINGS

FIG. 1 is a schematic diagram of an existing mobile communication network;

FIG. 2 is a flow chart of a call processing method according to an embodiment of the invention;

FIG. 3 is a schematic diagram of call processing according to one embodiment of the invention;

FIG. 4 is a schematic diagram of call processing according to another embodiment of the invention; and

FIG. 5 is a schematic diagram of a call processing system according to an embodiment of the invention.

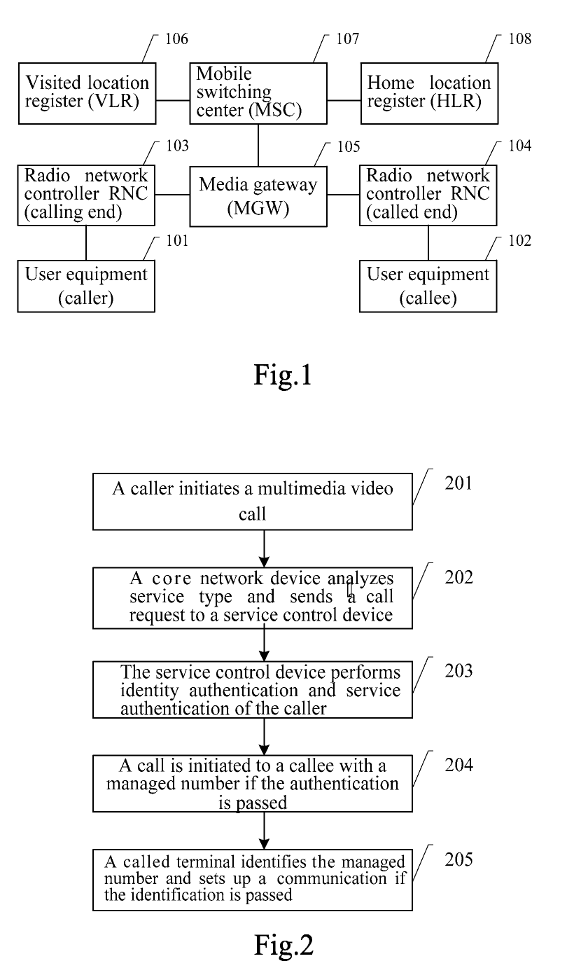

### DETAILED DESCRIPTION OF THE INVENTION

The embodiments of the invention provide a call processing method, a service control device and a call processing system, including: a correspondence relationship between a called number and a managed number is pre-established; service authentication of a caller is performed upon reception of information on a call request initiated by the caller to the called number; a call to the called number is initiated with the management number after authentication is passed; and a called terminal identifies the managed number and sets up communication with the caller after identification is passed, thereby avoiding direct calling by the caller to the called number without any authentication flow.

Referring to FIG. 2, it is a flow chart of a call processing method according to an embodiment of the invention, including:

Step 201: A caller initiates a multimedia video call to a called number.

Step 202: A core network device analyzes a service according to the call request, and sends a video call request to a service control device if the service is a video service for which service authentication is required.

Step 203: The service control device performs identity authentication and service authentication of the caller respectively according to caller identity information and caller service information.

S204: If the caller identifier and the caller service pass authentication, then a call is initiated to the called number with a managed number; otherwise, the call initiated by the calling user is terminated.

Step 205: A terminal to which the called number belongs identifies the managed number, and sets up communication with the caller if identification is passed.

The managed number refers to a unique specific number set for each called number as required for a service, and has a one-to-one correspondence relationship with a real number. For instance, a real number of the called number is 13866666666, and the corresponding managed number is 2001234. The managed number can be set at the service control device. The calling user can not know the correspondence relationship between the real number and the managed number. The called terminal only accepts a call initiated from the corresponding managed number, so that the called terminal can be called successfully from the calling number only after service authentication of the calling number is passed and the call to the callee is initiated from the managed number.

The above authentication can be performed in two ways, 1. firstly identity authentication of the caller is performed; the call is terminated if identity authentication fails and service authentication of the caller is further performed if identity authentication is passed; and the call is terminated if service authentication fails, and the call is initiated to the callee if service authentication is passed. 2. both identity authentication and service authentication are performed; and the call is terminated if identity authentication of the caller and/or service authentication of the caller fails, and the call is initiated to the callee only if both identity authentication of the caller and service authentication of the caller are passed.

The technical solutions are described in detail below in connection with the embodiments for further understanding of the invention.

### THE FIRST EMBODIMENT

Currently, mobile video phones have been applied widely, and systemic devices and terminals have been mature. With the development of global 3G networks, mobile video services have an inestimable development perspective. In future years, services in service fields of image, text, data and the like will surpass far the traditional voice communication field, and applications of various mobile terminals and emergence of more services will enrich the life of people tremendously, so that scene intercourse in the ultimate scenario of Face to Face (F2F) for human intercommunication can be achieved, with the use of a mobile visual terminal, people can share experiences and emotions, obtain information and entertainment and communicate with others, thereby a new communication approach and service enjoyment are provided. Since circuit domain video phone services can be spread with a lost cost, and are easy to operate and simple to use and also are consistent with the standard of 3G-324M clients, therefore operators can spread the circuit domain video phone services more easily.

The 3G-324M is the first multimedia terminal standard established by the 3GPP, which is suitable for the Third Generation Communication system (3G), and is consisted of error-tolerant video and audio coding and H.324 mobile extended terminal standards. The 3G-324M standard established by the 3GPP includes two files, i.e., TS 26.112 regarding setting-up of a circuit switched call and TS26.111 regarding a 3G-324M operation process.

The technical solutions will be described below which are implemented based upon the 3G-324M mechanism.

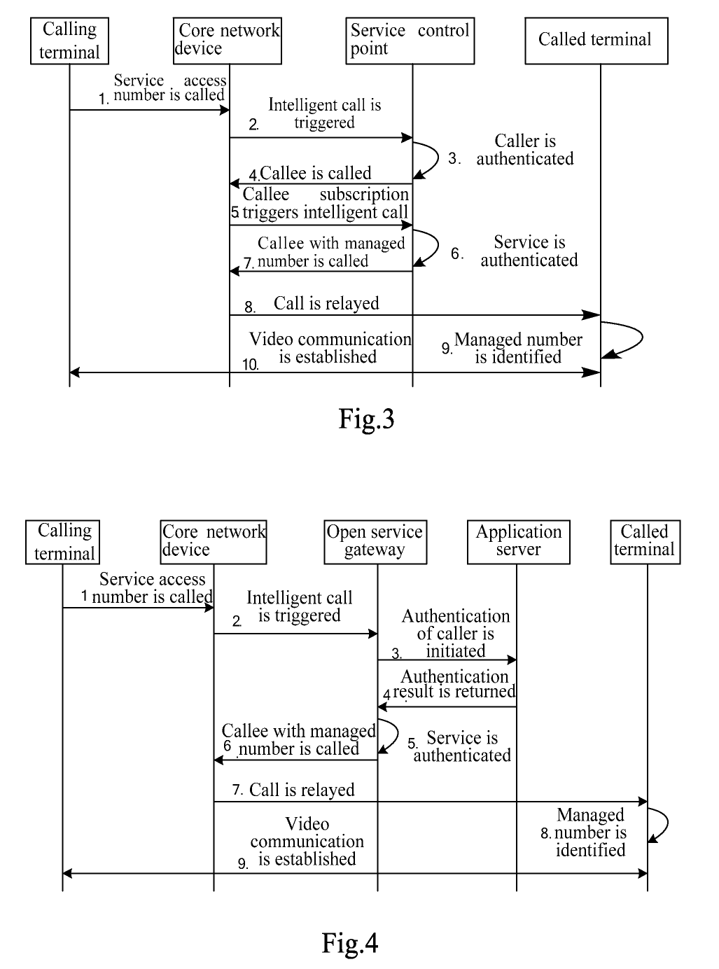

Referring to FIG. 3, it is a schematic diagram of call processing according to the first embodiment of the invention, where a core network device refers to a network device such as an MGW, an MSC and an HLR, and the service control device mentioned above refers particularly to a Service Control Point, SCP, in this embodiment.

(1) A user initiates a video phone call by dialing an access number of a video service.

(2) The radio core network device analyzes according to the access number and obtains a service type having a service attribute which requires authentication, and relays the call request to the SCP for proceeding of the call, that is, triggers an intelligent call.

(3) The SCP performs identity authentication of the caller according to a calling number and a password.

(4) The SCP initiates a call to a callee if authentication is passed and terminates the service if authentication is not passed.

(5) Subscription of the callee triggers an intelligent call, that is, a call request is relayed to the SCP for proceeding of the call when the call request is initiated to the callee.

(6) The SCP performs service authentication of the caller, inquires a list of calling numbers authorized by the callee and determines whether the caller is in the list of authorized numbers.

(7) A managed number corresponding to the called number is obtained if service authentication is passed; and a video call is initiated to the called number with the managed number, and the service is terminated if authentication is not passed.

(8) The core network device relays the video call to a called terminal.

(9) The terminal to which the called number belongs identifies the managed number and feeds back information indicating allowance of setting up communication if identification is passed.

For the identification, the called terminal presets an acceptable managed number, determines whether a managed number in the call information is identical to the preset managed number upon reception of the call information carrying the managed number, and if they are identical, which indicates that the call is valid, then the terminal feeds back information indicating allowance of setting up communication; and if they are not identical, which indicates that the call is invalid, then the terminal terminates the call.

(10) The caller and the callee sets up video communication.

### THE SECOND EMBODIMENT

Referring to FIG. 4, it is a schematic diagram of call processing according to the second embodiment of the invention, where a core network device refers to a network device such as an MGW, an MSC and an HLR, and the service control device mentioned above refers particularly to an Open Service Gateway, OSG, in this embodiment.

(1) A user initiates a video phone call by dialing an access number of a video service.

(2) The radio core network device analyzes according to the access number and obtains a service attribute having a service type which requires authentication, and relays the call request to the OSG for proceeding of the call.

(3) The OSG initiates a caller identity authentication request to an application server.

(4) The application server authenticates the caller according to a calling number and a password and returns an authentication result to the OSG. The Application server returns an authentication success response if authentication is passed and terminates the service if authentication is not passed.

(5) The OSG inquires a list of calling numbers authorized by the callee and determines whether the caller is in the list of authorized numbers. If the calling number is in the list of numbers for which an access to the callee is allowed, then service authentication is passed; and if the calling number is not in the list of numbers for which an access to the callee is allowed, then service authentication is not passed and the service is terminated.

(6) The OSG obtains a managed number corresponding to the called number and initiates a call to the callee with the managed number.

(7) The core network device relays the video call to a called terminal.

(8) The terminal to which the called number belongs identifies the managed number and feeds back information indicating allowance of setting up communication if identification is passed.

(9) The caller and the callee sets up video communication.

As can be seen from the above two embodiments, the technical solutions can enhance security of the use of a video phone service and can be applicable especially to those services in which only an authorized user can obtain on-site information. Improved security plays an important role in spreading applications of video phones, and therefore the invention has a high commercial application value.

The above solutions have been described only the embodiments of the invention applied in a wireless network, but implementations of the invention in a wired network, for example, a fixed telephone network, shall not be excluded.

The invention is not limited to applications in the field of video phones. The invention is also applicable to voice phones with a high security requirement, for example.

A service control device of the invention includes a data storage unit adapted to store data of a correspondence relationship between a called number and a managed number; a service authentication unit adapted to perform service authentication of a caller upon reception of information on a call request initiated from the caller to a called number; an identity authentication unit adapted to perform identity authentication of the caller prior to service authentication; a managed number inquiry unit adapted to inquire the data storage unit about the managed number corresponding to the called number after the caller passes service authentication; and a call initiation unit adapted to initiate a call to the called number through the managed number.

The service control device is particularly an SCP or an OSG.

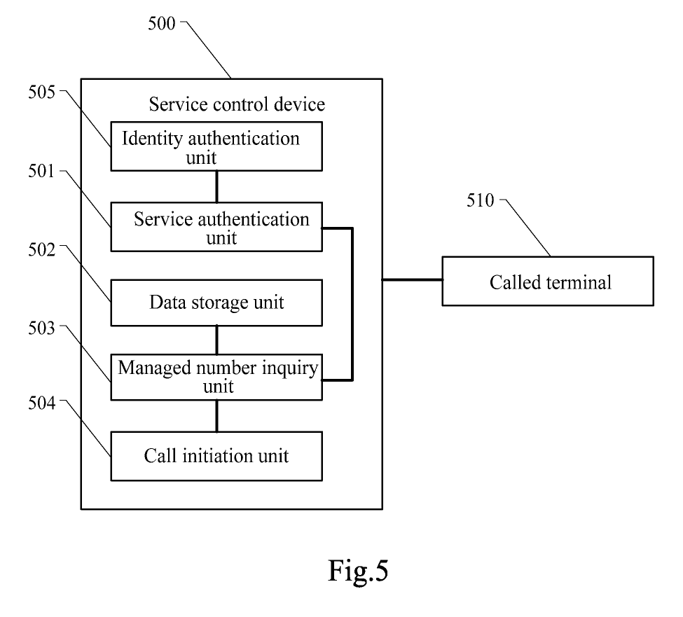

Referring to FIG. 5, it is a schematic diagram of a call processing system according to an embodiment of the invention, and the system includes a service control device 500 and a called terminal 501.

Particularly, the service control device 500 includes: a service authentication unit 501 adapted to perform service authentication of a caller upon reception of information on a call request initiated from the caller to a called number; an identity authentication unit 505 adapted to perform identity authentication of the caller prior to service authentication; a data storage unit 502 adapted to store data of a correspondence relationship between a called number and a managed number; a managed number inquiry unit 503 adapted to inquire the data storage unit 502 about the managed number corresponding to the called number after the caller passes service authentication; and a call initiation unit 504 adapted to initiate a call to the called number with the managed number.

The called terminal 510 identifies the managed number upon reception of call information carrying the managed number and feeds back information indicating allowance of setting up communication after identification is passed.

The service control device 500 is an SCP, or an OSG and an application server.

The system operates in a flow as follows: The identity authentication unit 505 of the service control device 500 performs identity authentication of a caller upon reception of information on a call request initiated from the caller to a called number. The service authentication unit 501 performs service authentication of the caller after identity authentication is passed. The managed number inquiry unit 503 inquires the data storage unit 502 about the managed number corresponding to the called number and sends the managed number to the call initiation unit 504. The call initiation unit 504 sends a call to the called number with the managed number. The called terminal 510 identifies the managed number and feeds back information indicating allowance of setting up communication after identification is passed. The caller and the callee sets up communication.

The call processing method, the service control device and the call processing system provided according to the invention have been described in detail as above. The principle and embodiments of the invention have been set forth by way of specific examples, and the descriptions of the embodiments are merely for understanding of the inventive method and the core idea thereof. Those skilled in the art can make changes to the embodiments and their application scopes in light of the spirit of the invention. Accordingly, the descriptions shall not be taken as limiting the invention.

What is claimed is:

1. A call processing method, comprising:
receiving a call request comprising a called number from a caller;
authenticating the caller;
obtaining a managed number corresponding to the called number according to a preset correspondence relationship between the called number and the managed number after the caller passes authentication; and
initiating a call to the called number with the managed number.

2. The method according to claim 1, wherein the call request is a multimedia video call request.

3. The method according to claim 1, wherein the authentication comprises identity authentication and service authentication of the caller; and the process of performing identity authentication and service authentication of the caller comprises:
performing firstly identity authentication of the caller, and then performing service authentication of the caller after identity authentication is passed; or
performing concurrently identity authentication and service authentication of the caller.

4. The method according to claim 2, wherein the authentication comprises identity authentication and service authentication of the caller; and the process of performing identity authentication and service authentication of the caller comprises:
performing firstly identity authentication of the caller, and then performing service authentication of the caller after identity authentication is passed; or
performing concurrently identity authentication and service authentication of the caller.

5. The method according to claim 1, further comprising: identifying, by a terminal to which the called number belongs, the managed number upon reception of the call carrying the managed number, and setting up communication with the caller after identification is passed.

6. A service control device, comprising:
a service authentication unit adapted to receive a call request comprising the called number from a caller and to perform service authentication of the caller;
a managed number inquiry unit adapted to inquire a data storage unit about a managed number corresponding to the called number after the caller passes service authentication; and
a call initiation unit adapted to initiate a call to the called number with the managed number.

7. The service control device according to claim 6, wherein:
the data storage unit is adapted to store data of a correspondence relationship between a called number and the managed number.

8. The service control device according to claim 6, further comprising an identity authentication unit adapted to perform identity authentication of the caller prior to service authentication.

9. The service control device according to claim 6, wherein the service control device is a service control point or an open service gateway.

10. The service control device according to claim 8, wherein the service control device is a service control point or an open service gateway.

11. A call processing system, comprising: a service control device adapted to communicate with a called terminal; wherein
the service control device is further adapted to receive a call request comprising a called number from a caller, to authenticate the caller, to obtain a managed number corresponding to the called number according to a preset correspondence relationship between the called number and the managed number after the caller passes authentication and to initiate a call to the called number with the managed number; and
the called terminal is adapted to identify the managed number and to set up communication with the caller after identification is passed.

12. The call processing system according to claim 11, wherein the service control device comprises:
a data storage unit adapted to store data of the correspondence relationship between the called number and the managed number;
a service authentication unit adapted to receive the call request comprising the called number from the caller and to perform service authentication of the caller;
a managed number inquiry unit adapted to inquire the data storage unit about the managed number corresponding to the called number after the caller passes service authentication; and
a call initiation unit adapted to initiate a call to the called number with the managed number.

13. The call processing system according to claim 12, wherein the service control device further comprises an identity authentication unit adapted to perform identity authentication of the caller prior to service authentication.

14. The call processing system according to claim 11, wherein the service control device is a service control point, or the service control device is an open service gateway and an application server.
